(19) United States
(12) Patent Application Publication
(10) Pub. No.: US 2007/0287443 A1
(43) Pub. Date: Dec. 13, 2007

(54) Method for managing a communication system extending over at least one cell for wireless communication between mobile units with direct wireless communication possibilities limited to and/or extending over a cell synchronized to a base station

(76) Inventor: Stefan Hulder, DORSTEN-DEUTEN (DE)

Correspondence Address: STAAS & HALSEY LLP, SUITE 700, 1201 NEW YORK AVENUE, N.W., WASHINGTON, DC, 20005, US

(21) Appl. No.: 11/661,371

(22) PCT Filed: Jul. 3, 2006
(86) PCT No.: PCT/EP06/63780

§ 371 Date: Feb. 28, 2007

(30) Foreign Application Priority Data
Jul. 1, 2005 (DE) 10 2005 030 830.9

(51) Int. Cl. H04Q 7/20

(52) U.S. Cl. 455/422.1

(57) ABSTRACT

A method manages a communication system extending over at least one cell for wireless communication between mobile unites with direct wireless communication possibilities limited to and/or extending over a cell synchronized to a base station such that two identification numbers, used for managing the communication system with the given direct communication possibility between the mobile units both coming from a common number bank, do not collide, wherein at least one information unit from a first information bank of unique address information used for the management of a cellular communication system is provided for a second information bank for the formation of one of two identification numbers, such that in order to form said identification numbers access is no longer possible to a large number of information units without thus changing the size of the banks and a comparison of both identification numbers is necessary for the unique address information.

### CROSS REFERENCE TO RELATED APPLICATIONS

This application is based on and hereby claims priority to Application No. PCT/EP2006/063780 filed on Jul. 3, 2006 and German Application No. 10 2005 030 0830.9 filed Jul. 1, 2005, the contents of which are hereby incorporated by reference.

### BACKGROUND

The manner in which the method for managing a communication system extending over at least one cell for wireless communication, preferably a DECT system (Digital Enhanced Cordless Telecommunication), between mobile units with direct wireless communication possibilities (DECT Distributed Communication, DDC) limited to and/or extending over a cell synchronized to a base station, functions in accordance with related art is shown in FIGS. 1 to 4. Thereby, by referring to the relevant chapters in the DECT Standard EN 300 175-1 . . . 8, November 2004, one is introduced to the subject “Distributed Communication according to the DECT Standard”.

The DECT standard (cf.: EN 300 175-5, Chapter I.3.10.2, November 2004) states that for “Single Cell” based DECT systems, unique “Identity Numbers” (IdN) can be allocated from a number area, the so-called RPN area (Radio fixed Part Number), available in the DECT system, whereas for multi-cell based DECT systems (CMI based DECT systems, Cordless Multicell Integration) it is just specified that during the allocation, “Radio fixed Part Numbers” (RPNs) of active fixed parts or base stations (Radio Fixed Part, RFP) may not be used as “Identity Numbers”. But no method is given as to how this can be provided. The wording concerning this used in the standard allows one to assume, however, that with the allocation one requires a management that is also quite usual in larger business systems (e.g. HICOM based cordless systems).

Moreover, it is possible to expand small “Single Cell” based DECT systems for home use to CMI based DECT systems by adding an intermediate station or radio relay station, the so-called repeater (Cordless Radio Fixed Part, CRFP).

FIG. 1 shows such a CMI based DECT communication system KS. The multi-cell communication system KS has a first radio cell FZI, which cell serves as a radio coverage area for a DECT base station BS and in which, in addition to the base station BS, there are arranged five mobile units MT1 . . . MT5, all of which have a radio connection to the base station BS. The base station BS, which for its power supply is connected to a voltage network SPN via a power supply unit NAG, is connected to the landline network either via telecommunication adapter equipment TAE or a private branch exchange NStA. In addition, there is a telecommunication terminal TKE connected to the base station BS, which terminal TKE can be designed preferably as a bell system, fax machine, personal computer etc.

Of the five mobile units MT1 . . . MT5, a first mobile unit MT1 maintains an EXTERN connection EXV to an extern subscriber in the landline network via the base station BS, while a second mobile unit MT2 and a third mobile unit MT3 each maintains an INTERN connection INV to the base station BS for system internal communication. In addition to this INTERN connection INV between the second mobile unit MT2 and the third mobile unit MT3, there is in the first radio cell FZI of the communication system KS also a first DIRECT connection DVI between a fourth mobile unit MT4 and a fifth mobile unit MT5.

Because of this additional direct connection option between the fourth mobile unit MT4 and the fifth mobile unit MT5 (Distributed Communication), in the communication system KS in accordance with the DECT standard (cf.: EN 300 175-5 VI. 8.1, November 2004, Annex I) one talks about a “Distributed Communication DECT Local Network (DCDL-Net)”. Those subscribers of a “Distributed Communication DECT Local Network”, who can make a DIRECT connection, are called “Members” and must have the capabilities of both a “Portable Termination (PT)” and a “Fixed Termination (FT)”. Therefore, they are also called hybrid mobile units, so that the fourth mobile unit MT4 is a first hybrid mobile unit H-MTI and the fifth mobile unit MT5 is a second hybrid mobile unit H-MT2. The role of the “Master” in the “Distributed Communication DECT Local Network” can, in principle, be assumed by any “DCDL Net” terminal, hence also by a “Member”. However, this is preferably perceived by the base station of the “Distributed Communication DECT Local Network, because it is self-evident.

In addition to the first radio cell FZI, the communication system KS has, in the course of upgrading from a “Single Cell” system to a “Multi-Cell” system, another two radio cells, a second radio cell FZ2 and a third radio cell FZ3. In a first overlap area ÜLBI between the first radio cell FZI and the second radio cell FZ2 and in a second overlap area ÜLB2 between the first radio cell FZI and the third radio cell FZ3, there are repeaters designed as an intermediate station or radio relay station, a first repeater RP1 in the first overlap area ÜLBI and a second repeater RP2 in the second overlap area ÜLB2. Both repeaters RPI, RP2 are, as is the base station BS in the first radio cell FZI, connected to a voltage network SPN via a power supply unit NAG. The first repeater RPI has a wireless connection to two further mobile units, a sixth mobile unit MT6 and a seventh mobile unit MT7, both of which are in the second radio cell FZ2 outside the first radio cell FZI. Between the sixth mobile unit MT6 and the seventh mobile unit MT7 there is a second DIRECT connection DV2, and for this reason the sixth mobile unit MT6 is called a third hybrid mobile unit H-MT3 and the seventh mobile unit MT7 a fourth hybrid mobile unit H-MT4.

The base station BS, which, as “Master” of the communication system KS, has to allocate an “Identity Number” (IdN) to each “Member” in the first and second radio cell FZI, FZ2 of the communication system KS, has, however, with respect to the third and fourth hybrid mobile units H-MT3, H-MT4 in the second radio cell FZ2, no knowledge as to which “Radio fixed Part Numbers” are allocated by the first repeater RPI. On the other hand, during the process of allocating the “Radio fixed Part Number”, the first repeater RPI has no knowledge as to which “Radio fixed Part Number” is already blocked as an “Identity Number”. Thus the only way to achieve a collision-free allocation of the “Identity Number” and “Radio fixed Part Number” is by having an overriding management, which, in the case of small DECT systems for the home market, one either does not want or is not able to implement.

FIG. 2 shows how the resource “Time” is occupied in the DECT based multi-cell communication system KS (time slot occupation) where the INTERN connection INV is a known connection option between two mobile units, here, for example, the second mobile unit MT2 and the third mobile unit MT3.

Internal connections in DECT based communication systems are, as a rule, solved in such a way that both subscribers or rather both mobile units have a connection to the base station that connects the two data streams. As, with an INTERN connection through the base station, more bandwidth is occupied than is actually required for the payload transmission—the double bandwidth is occupied—and at the same time the bandwidth available to the base station is limited, the setting up of an INTERN connection proves to be especially disadvantageous when internal connections with higher data volume are created.

In order to set up the INTERN connection INV between the mobile units MT2, MT3 in the communication system KS according to FIG. 1, the following time slots, for example, are occupied in accordance with FIG. 2: the time slots “2” and “14” are used for the connection (duplex connection) between the base station BS and the second mobile unit MT2, while the time slots “4” and “16” are occupied for the connection (duplex connection) between the base station BS and the third mobile unit MT3.

FIG. 3 shows how the resource “Time” is occupied in the DECT based multi-cell communication system KS (time slot occupation) where the DIRECT connections (Distributed Communications) DVI, DV2 are a direct, immediate connection option between two hybrid mobile units, here, for example, the first mobile unit H-MTI and the second mobile unit H-MT2 or the third mobile unit H-MT3 and the fourth mobile unit H-MT4.

To set up a “Distributed Communication”, at least the hybrid mobile unit to be called must carry out an “Idle Receiver Scanning” for “Bearer-Request-Messages” as described in the DECT standard (cf.: EN 300 175-3, Paragraph 11.8, November 2004) for base stations.

As this “Idle Receiver Scanning” uses a lot of energy, as a rule hybrid mobile units will not carry out the “Idle Receiver Scanning” continuously. In one embodiment, a hybrid mobile unit to be called will not start “Idle Receiver Scanning” until it has been otherwise prompted to do so. The DECT standard provides a procedure called “Indirect Link Establishment” to this end (cf.: EN 300 175-5, Paragraph I.3.8, November 2004).

Alternatively, a known intern connection can be used to initiate the establishment of a “Distributed Communication”, thus also to activate the “Idle Receiver Scanning” in the hybrid mobile unit to be called. This is the preferred alternative used in GIGASET cordless phones so far, in order to minimize the amount of change and preliminary performance in the base station of the telephones.

For the further setup of connections in a “Distributed Communication”, the known rules for a “Connection and Bearer Setup” can then be applied, as described in the DECT standard (cf.: EN 300 175-3, Chapters 10.2 and 10.5, November 2004). Within these procedures, the calling hybrid mobile unit behaves like a normal mobile unit (Portable Part) and the called hybrid mobile unit like a base station (Fixed Part).

The time slot occupation for the first DIRECT connection DVI between the first mobile unit H-MTI and the second mobile unit H-MT2 in the communication system KS in accordance with FIG. 1, is carried out according to the above embodiments in accordance with FIG. 2 e.g. as follows:

The time slot “2” is used for the transmission of the “Bearer-Request-Messages” from the base station BS to the first hybrid mobile unit H-MTI and/or to the second hybrid mobile unit H-MT2, while the time slots “4” and “16” are occupied for the “Connection and Bearer Setup” of the DIRECT connection DVI between the first hybrid mobile unit H-MTI and the second hybrid mobile unit H-MT2.

The time slot occupation for the second DIRECT connection DV2 between the third mobile unit H-MT3 and the fourth mobile unit H-MT4 in the communication system KS in accordance with FIG. 1 occurs, although not represented in FIG. 2, in principle by analogy, whereby, in this case the “Master” is not the base station BS, but the first repeater RP1.

FIG. 4 shows a unique address information [“Radio Fixed Part Identity” (RFPI)] used to manage the DECT based multi-cell communication system KS. Before elaborating on the address information and its content, first, with reference to the DECT standard, a few general comments on this address information in relation to the “Distributed Communication”.

For the “Idle Receiver Scanning” and the “Connection and Bearer Setup” procedure when setting up the “Distributed Communication”, it is important that the individual hybrid mobile units (Member) are uniquely identifiable.

“Radio Fixed Part Identity (RFPI)” and “Fixed Part MAC IDentity (FMID)” identities are required for the “Bearer Setup” procedure, whereby the “Fixed Part MAC IDentity” represents only the last 12 bits of the “Radio Fixed Part Identity”. The “Radio Fixed Part Identity”, with which a “Member” operates the setting up of a “Distributed Communication”, results in accordance with the DECT standard (cf.: EN 300 175-5, Chapter I.3.10.2, November 2004) from an “Access Rights Identity (ARI)” of the “Master” (base station) and the unique “Identity Number” (IdN) of each “Member” (hybrid mobile unit).

Thus the “Identity Number” is the final number of the “Radio Fixed Part Identity”, which the hybrid mobile unit uses for the “Distributed Communication”, in as far as the hybrid mobile unit is the called subscriber of the “Distributed Communication” and, therefore, assumes the role of the “Fixed Part” in the “Connection Setup”.

But the “Identity Number” is also very similar to the “Radio fixed Part Number” (RPN) of a known fixed part or of a known base station (cf.: EN 300 175-6, Chapter 5, November 2004). For the “Access Rights Classes” defined in the DECT standard, in “Access Rights Class A” the “Radio fixed Part Number” is 3 bit wide and in “Access Rights Classes B, C, D, E” respectively 8 bit wide. The “Identity Number” is in principle 8 bits wide according to the DECT standard (cf.: EN 300 175-5, Chapter I.3.10.1, November 2004). However, Chapter I.3.10.2 of the DECT standard also restricts the use of the “Identity Number” for the “Access Rights Class A” to the last 3 bits.

According to the DECT standard (cf.: EN 300 175-5, Chapter I.3.2 und I.3.10.3, November 2004) the “Identity Number” is assigned to the individual “Member” by the “Master” as part of a “Membership Access Rights Allocation” procedure.

In principle, for this the requirement applies that the “Radio fixed Part Number” used must not be used again as an “Identity Number”. This also applies to the previously mentioned “Single Cell” systems, where the respective base station has already allocated a “Radio fixed Part Number”, which number is thus blocked for use as an “Identity Number”.

In order to manage the DECT based multi-cell communication system KS, according to FIG. 4 a first address information ADI1 for the base station BS and the repeaters RPI, RP2 are used to identify communication connections, while a second address information ADI2 for the “Member” is used to identify the respective member.

The address information ADI1, ADI2 contains information units IE, which are distributed preferably as bits onto an information head IK, the so-called Header, a preset—in the sense of being defined once only—first bank V1 and an alterable second bank V2 in that order.

The bits contained in the information head IK of the first address information ADI1 have any value “E”, while the bits contained in the information head IK of the second address information ADI2 have a value of “E=0”.

The information units IE that are contained in the first banks V1 of the address information ADI1, ADI2, form an identifier KE, which, in this case, where the communication system KS is a DECT system, corresponds substantially to the “Access Rights Identity” ARI.

The information units IE, which are contained in the second bank V2 of the first address information ADI1, form a first identification number IN1, while the information units IE, which are contained in the second bank V2 of the second address information ADI2, form a second identification number IN2.

The address information ADI1, ADI2′, the identifier KE, the first identification number IN1 and the second identification number IN2 respectively correspond substantially to the “Radio Fixed Part Identity” RFPI specified in the DECT standard, to the “Access Rights Identifier” ARI, to the “Radio Fixed Part Number” RPN and to the “Identity Number” IdN, while the size of the second information bank IE, V2 is preferably three or eight bits in accordance with the DECT standard.

As already mentioned in the introduction, with “Single Cell” systems there is normally no danger of the “Identity Number” colliding with the active “Radio fixed Part Number” (RPN),

Because the entire RPN area, with the exception of the “Radio fixed Part Number” of the sole base station, is available for the allocation of “Identity Numbers” and this RPN area is, as a rule, sufficient.

The same statement does not apply for DECT based multi-cell communication systems.

With respect to such multi-cell communication systems, the DECT standard only describes the requirement for non-conflicting “Identity Numbers” and “Radio fixed Part Numbers” and it is given to understand that the collision problem can apparently only be solved by an overriding management, which would not be economical for customary DECT cordless telephones (small home systems).

According to the guidelines in the DECT standards (cf.: EN 300 175-5, Annex I, November 2004) “Radio Fixed Part Identities (RFPI)” differ from hybrid mobile units and “Radio Fixed Part Identities (RFPI)” differ from base stations of a DECT system only in the RPN area. “Radio fixed Part Number” and “Identity Number” must therefore be managed in such a way that they do not collide.

### SUMMARY

One possible object underlying the invention is to specify a method for managing a communication system extending over at least one cell for wireless communication between mobile units with direct wireless communication possibilities limited to and/or extending over a cell synchronized to a base station, wherein two identification numbers used to manage the communication system with the given direct communication possibility between the mobile units, and which numbers both derive from a common number bank, do not collide.

The inventors propose that at least one information unit from a first information bank of a unique address information used for the management of a cellular communication system between mobile units with wireless direct communication possibilities limited to and/or extending over a cell, is provided for a second information bank for the formation of one of two identification numbers such that in order to form said identification numbers access is now possible to a larger number of information units without thus changing the size of the banks and without a comparison of the two identification numbers being necessary for the unique address information.

If the network in question is a “Distributed Communication DECT Local Network”, then the aim targeted with this measure will be achieved, to prevent a mutual blocking when using a “Radio fixed Part Number” and an “Identity Number” in the “Distributed Communication DECT Local Network”.

### BRIEF DESCRIPTION OF THE DRAWINGS

These and other objects and advantages will become more apparent and more readily appreciated from the following description of the preferred embodiments, taken in conjunction with the accompanying drawings of which:

FIG. 1 shows a DECT based multi-cell communication system,

FIG. 2 shows a time slot occupation in a known INTERN connection in the DECT based multi-cell communication system,

FIG. 3 shows a time slot occupation in a DDC connection in the DECT based multi-cell communication system,

FIG. 4 shows a unique address information [“Radio Fixed Part Identity” (RFPI)] available for managing the DECT based multi-cell communication system in accordance with the DECT standard.

### DETAILED DESCRIPTION OF THE PREFERRED EMBODIMENT

Reference will now be made in detail to the preferred embodiments, examples of which are illustrated in the accompanying drawings, wherein like reference numerals refer to like elements throughout.

As described below, an “Identity Number” can be allocated without knowledge of the “Radio fixed Part Number” used in the system and in part deviating from the rules described in the DECT standard (cf.: EN 300 175-5, Chapter I, November 2004) without resulting in a collision between the two identification numbers.

The separation of “Radio Fixed Part Identities” for the mobile units with direct communication ability, the hybrid mobile units, and “Radio Fixed Part Identities” for base stations and repeaters is achieved by different “Access Rights Identifiers (ARI)” in the “Radio Fixed Part Identities”. The allocation/reservation of further “Access Rights Identifiers (ARI)” for the hybrid mobile units is only necessary in order to reserve more encodings for “Identity Numbers”, which lead to unique “Radio Fixed Part Identities” without comparison with the “Radio fixed Part Numbers” used.

For this, the “Identity Number” is not only restricted to the RPN area of the “Radio Fixed Part Identity”, but must also overlap the end part of the “Access Rights Identifier”. That is simple to achieve in “Access Rights Class A” with a 3 bit wide “Radio fixed Part Number” and an 8 bit wide “Identity Number”. For the higher “Access Rights Classes” with an 8 bit wide “Radio fixed Part Number”, the “Identity Number” must be encoded correspondingly wider.

The “Access Rights Identifier” of the base station (of the “Master”) remains the sole unique “Access Rights Identifier” for the “Distributed Communication DECT Local Network”, for synchronizing and checking the access authorization. The “Access Rights Identifier” must be worldwide unique for most “Access Rights Classes” (cf.: EN 300 175-6, Chapter 5.1). As a rule that is ensured by the manufacturer in the production. If, as in this method, the “Master” allocates the “Identity Number”, so that implicitly additional “Access Rights Identifiers” are allocated for the hybrid mobile units, then the manufacturer must reserve these additional “Access Rights Identifier” for this “Master” as well, to ensure that these additional “Access Rights Identifier” are also unique worldwide.

The separation of the “Radio Fixed Part Identities” for hybrid mobile units and known “Radio Fixed Part Identities” (repeater and/or base station) achieved by this method renders unnecessary a complex management of the allocation of the “Identity Number” and “Radio fixed Part Number”, which would, for economic reasons, not be achievable with cordless telephones (small home systems).

The “Identity Number” is not, as described in the DECT standard (cf.: EN 300 175-5, Chapter I, November 2004), allocated in the RPN area of the “Radio Fixed Part Identity”, which would necessitate a comparison between “Radio fixed Part Number” and “Identity Number” allocation to avoid double allocations. The “Identity Numbers” for hybrid mobile units are selected in such a way that they also overlap the end part of the “Access Rights Identifier” and differ in this part from the “Access Rights Identifier” of already existing “Radio Fixed Part Identities”. In this way, the “Identity Number” allocation and “Radio fixed Part Number” allocation in a “Distributed Communication DECT Local Network” can be operated completely separately from each other.

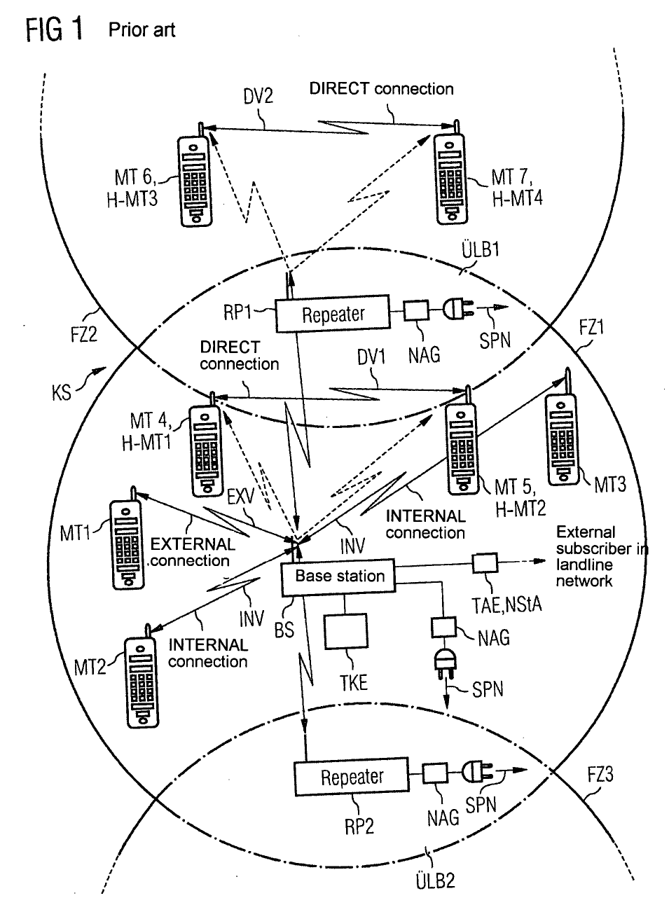

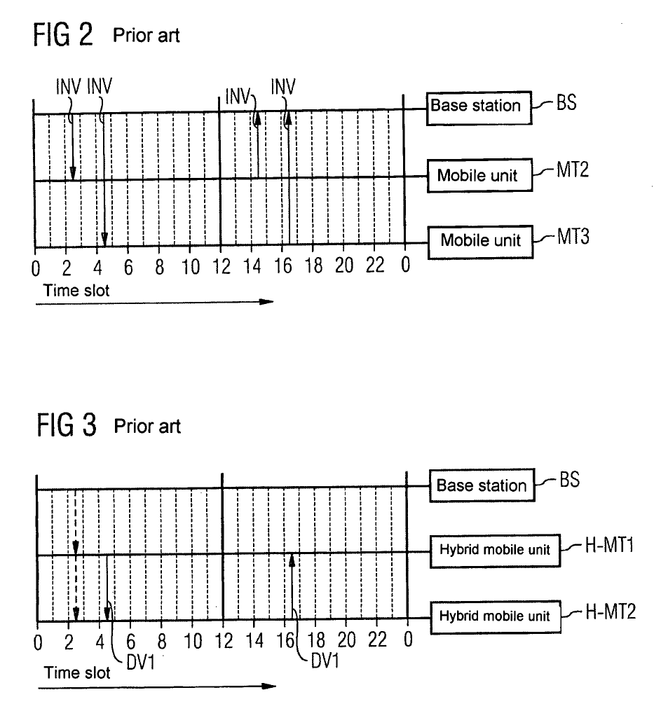

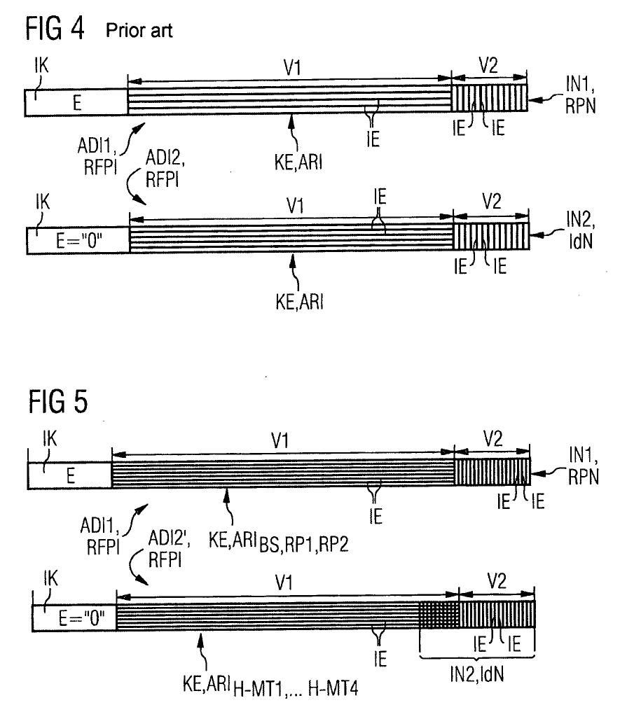

An exemplary embodiment is described on the basis of FIGS. 1 to 4 and with reference to FIGS. 5 and 6, in which;

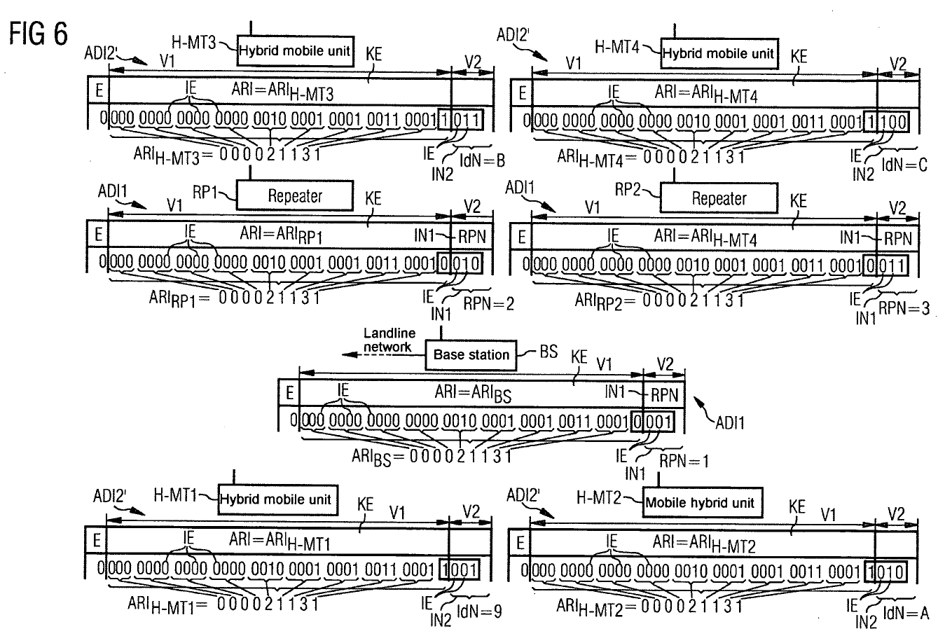

FIG. 5 shows a unique address information [“Radio Fixed Part Identity” (RFPI)] based on FIG. 4—the unchanged first address information and a modified second address information, for managing the DECT based multi-cell communication system,

FIG. 6 shows the encoding of the unique address information [“Radio Fixed Part Identity” (RFPI)] shown in FIG. 5 for managing the DECT based multi-cell communication system shown in FIG. 1.

FIG. 5 shows a unique address information [“Radio Fixed Part Identity” (RFPI)] based on FIG. 4—the unchanged first address information ADII for the base station BS and the repeaters RPI, RP2 and a (compared with the second address information ADI2 in FIG. 4) modified address information ADI2′ for the hybrid mobile units H-MT1, H-MT2, H-MT3, H-MT4—for managing the DECT based multi-cell communication system KS. The modification of the second address information ADI2 is necessary so that the “Radio fixed Part Number” used in a “Distributed Communication DECT Local Network” does not block a use of the “Identity Number” and vice versa. The general remarks, made otherwise with respect to FIG. 4 relating to the DECT standard, on the unique address information in connection with the “Distributed Communication” apply similarly to the modified second address information ADI2′.

The difference between the second address information ADI2 and the modified second address information ADI2′ is that with the modified address information ADI2′ from the first bank V1 of information units IE at least one information unit IE is provided for the second bank V2 of information units IE for the formation of the second identification numbers IN2.

Because it is now possible to resort to a greater number of information units IE to form the second identification number IN2 without changing the size of the banks V1, V2, the aim, targeted with this measure, of preventing a mutual blocking when using a “Radio fixed Part Number” and an “Identity Number” in the “Distributed Communication DECT Local Network”, is achieved.

The first identification number IN1 (cf. embodiments for the first address information ADI in FIG. 4) is preferably allocated by the system operator when the communication system KS is put into operation.

The second identification number IN2 is preferably allocated by base station BS when the mobile unit in question H-MTI, H-MT2, H-MT3, H-MT4 logs in directly or indirectly to the base station BS. The indirect logging in refers to logging in via the repeater RPI, RP2.

The size of the second information bank IE, V2 amounts, depending on the type of communication system KS, to at least two bits, whereby the respective type of communication system KS is encoded in the identifier KE.

The address information ADII, ADI2′, the identifier KE, the first identification number IN1 and the second identification number IN2 again respectively correspond to the “Radio Fixed Part Identity” RFPI, the “Access Rights Identifier” ARI, the “Radio Fixed Part Number” RPN and the “Identity Number” IdN specified in the DECT standard, while the size of the second information bank IE, V2 is, in accordance with the DECT standard, preferably amounts to three or eight bits.

FIG. 6 shows a possible encoding of the unique address information [“Radio Fixed Part Identity” (RFPI)] shown in FIG. 5 for managing the DECT based multi-cell communication system KS shown in FIG. 1—the unchanged first address information ADII of the base station BS and the repeater RPI, RP2 and the modified second address information ADI2′ of the hybrid mobile units H-MT1 . . . H-MT4. The encoding values are shown in the following table in Hex Code.

| Equipment | | | | |
|---|---|---|---|---|
| type | ADI1, ADI2′ (RFPI) | ARI | IdN | RPN |
| BS | 0 000021131 1 | 000021131 | | 1 |
| RP1 | 0 000021131 2 | 000021131 | | 2 |
| RP2 | 0 000021131 3 | 000021131 | | 3 |
| H-MT1 | 0 000021131 9 | 000021131 | 9 | |
| H-MT2 | 0 000021131 A | 000021131 | A | |
| H-MT3 | 0 000021131 B | 000021131 | B | |
| H-MT4 | 0 000021131 C | 000021131 | C | |

A description has been provided with particular reference to preferred embodiments thereof and examples, but it will be understood that variations and modifications can be effected within the spirit and scope of the claims which may include the phrase “at least one of A, B and C” as an alternative expression that means one or more of A, B and C may be used, contrary to the holding in Superguide v. DIRECTV, 358 F3d 870, 69 USPQ2d 1865 (Fed. Cir. 2004).

1-7. (canceled)

8. A method for managing a communication system extending over at least one cell for wireless communication between mobile units, each cell being synchronized by a respective base station, comprising:
copying an information unit from a first bank of information units to a second bank of information units, the second bank following the first bank in unique address information for the management of the communication system, the information unit copied to the second bank being the information unit of the first bank that is closest to the information units of the second bank;
using a first identification number to identify communication connections involving a base station within a cell of the communication system, the first identification number being formed from the second bank; and
using a second identification number to identify direct connections between mobile units, the second identification number being formed from the second bank and from the information unit of the first information bank that was copied to the second bank.

9. The method as claimed in claim 8, wherein
the first identification number is allocated by a system operator when the communication system is put into operation.

10. The method as claimed in claim 8, wherein
second identification numbers are allocated by the base station when respective mobile units log in directly or indirectly to the base station.

11. The method as claimed in claim 8, wherein
each information unit occupies one bit.

12. The method as claimed in claim 8, wherein
an identifier is formed from the first bank of information units.

13. The method as claimed in claim 11, wherein
an identifier is formed from the first bank of information units,
the identifier is encoded to identify a communication system type of the communication system,
the second bank has a size of at least two bits, and
the size of the second bank depends on the communication system type of communication system.

14. The method as claimed in claim 8, wherein
the communication system is a cordless telecommunication system specified according to a Digital Enhanced Cordless Telecommunication DECT standard,
the address information is a Radio Fixed Part Identity RFPI specified in the DECT standard,
an identifier to identify a communication system type of the communication system is formed from the first bank of information units,
the identifier is an Access Rights Identifier ARI specified in the DECT standard forms,
the first identification number is a Radio Fixed Part Number RPN specified in the DECT standard,
the second identification number is an Identity Number IdN specified in the DECT standard, and
the second bank is three or eight bits in length.

15. The method as claimed in claim 8, wherein a plurality of information units from the first bank are provided to the second bank.

16. The method as claimed in claim 8, wherein the second bank directly follows the first bank in the unique address information.

17. The method as claimed in claim 10, wherein
each information unit occupies one bit.

18. The method as claimed in claim 17, wherein
an identifier is formed from the first bank of information units.

19. The method as claimed in claim 18, wherein
the identifier is encoded to identify a communication system type of the communication system,
the second bank has a size of at least two bits, and
the size of the second bank depends on the communication system type of communication system.

20. The method as claimed in claim 19, wherein
the communication system is a cordless telecommunication system specified according to a Digital Enhanced Cordless Telecommunication DECT standard,
the address information is a Radio Fixed Part Identity RFPI specified in the DECT standard,
the identifier is an Access Rights Identifier ARI specified in the DECT standard forms,
the first identification number is a Radio Fixed Part Number RPN specified in the DECT standard,
the second identification number is an Identity Number IdN specified in the DECT standard, and
the second bank is three or eight bits in length.
